(19) United States
(12) Patent Application Publication
(10) Pub. No.: US 2008/0156841 A1
(43) Pub. Date: Jul. 3, 2008

(54) Pneumatic continuous feeder

(75) Inventor: Wen-Cheng Chen, Taoyuan County (TW)

Correspondence Address: Joe McKinney Muncy, PO Box 1364, Fairfax, VA, 22038-1364, US

(73) Assignee: SUN YIEH INDUSTRIAL CO., LTD.

(21) Appl. No.: 11/648,793

(22) Filed: Jan. 3, 2007

(51) Int. Cl. B65H 20/00; B26D 5/20

(52) U.S. Cl. 226/95; 83/277

(57) ABSTRACT

The present invention is a pneumatic continuous feeder which, through an air-pressure motive power source, can continuously drive a fixing clip to move back and forth equidistantly and also a mobile clip at the top of the fixing clip, so that when the fixing clip arrives the return point, the material can be downwardly clipped or upwardly released for achieving a continuous feeding. The present invention not only can precisely adjust the moving distance of material in processing for continuously and accurately driving the material to the operation tool, but also can change the driving method for the material to be pull or push in response to the hardness degree of the material.

### FIELD OF THE INVENTION

The present invention is related to continuous feeder, and more particularly to a pneumatic continuous feeder which can precisely drive the material to move to the operation tool for processing.

### BACKGROUND OF THE INVENTION

Currently, the conventional feeders have two problems urgently to be solved: one is that the movement of the material to be processed can not be driven precisely so that the problem of accumulated tolerance is always existed, and the other is the method for feeding the material can not be switched to be pull or push according to the property, such as soft or hard, of the material.

First, relating to the problem of accumulated tolerance, the reason is that, currently, no matter the feeding material is pushed or pulled, the turning motive force is always employed. For the pulling method, a rolling at the end is employed which may change the rolling speed cooperating with the variable factors (such as the rolled thickness generated from rolling the material in each second) for controlling the moving distance of the material. Therefore, since the soft material is continuously rolled up, if each second has an error of 0.1 mm, an error of 6 cm will be produced after 1 minute of rolling-up. As to the pushing method, since the pushing process is employed, the material must be thicker and have no concern in deformation, and thus, the material can be pushed to the area of operation tool for processing. However, when the rolling shaft drives the material, an error of 5 cm will be produced after moving the material for 5 m if each turn of the rolling shaft has an error of 0.1 mm. Consequently, it is obvious that the conventional feeder has the problem of accumulated tolerance which is vary serious for the manufacturing industry.

The other problem which needs to be solved is that the conventional feeder can not change the feeding method to be pull or push according to the hardness of material. Since the soft material can not be pushed to move forward, it has to roll up the material at the end after processed so as to achieve the feeding. On the contrary, because the hard material can not be rolled up, it has to be pushed to the area of operation tool, and then, a falling caused by the gravity itself is employed to collect the material. Therefore, the manufacturer can not use the feeder for the soft material to deal the hard material and vice versa, so that the purchase cost is significantly increased.

Consequently, a feeder which can solve the problems described above may indeed contribute a lot.

### SUMMARY OF THE INVENTION

The main purpose of the present invention is to solve the problems described above. According to the present invention, not only the moving distance of material in processing can be precisely adjusted for continuously and accurately driving the material to the operation tool, but the method for driving the material also can be selected to be pull or push in response to the hardness degree of material.

According to the object described above, the present invention provides a pneumatic continuous feeder used to precisely drive a material to an operation tool for processing includes a base having a push-forward rejecting element and a push-backward rejecting element; a moving unit having a fixing clip, which is driven by a cylinder to move back and forth on the base; an operation unit having a mobile clip, which is fixed overhead the fixing clip for downwardly clipping or upwardly releasing the material; and a brake unit having a wrench element, which is collided by the push-forward rejecting element and the push-backward rejecting element so as to generate a connecting rod operation for pressing the operation unit to move upwardly and downwardly, wherein through the cylinder continuously driving the fixing clip to move back and forth equidistantly and driving the mobile clip at the top of the fixing clip, the material can be downwardly clipped or upwardly released when the fixing clip arrives the return point, so as to achieve a continuous feeding.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a lateral view showing a pneumatic continuous feeder according to the present invention;

FIG. 2 is a partial front view showing a pneumatic continuous feeder according to the present invention;

FIGS. 3A˜3D are lateral views showing a first kind of operations of the pneumatic continuous feeder in a first embodiment according to the present invention;

FIGS. 4A˜4D are lateral views showing a second kind of operations of the pneumatic continuous feeder in a first embodiment according to the present invention; and

FIG. 5A and FIG. 5B are lateral views showing the adjusting operations for the movement of the pneumatic continuous feeder according to the present invention.

### DESCRIPTION OF THE PREFERRED EMBODIMENT

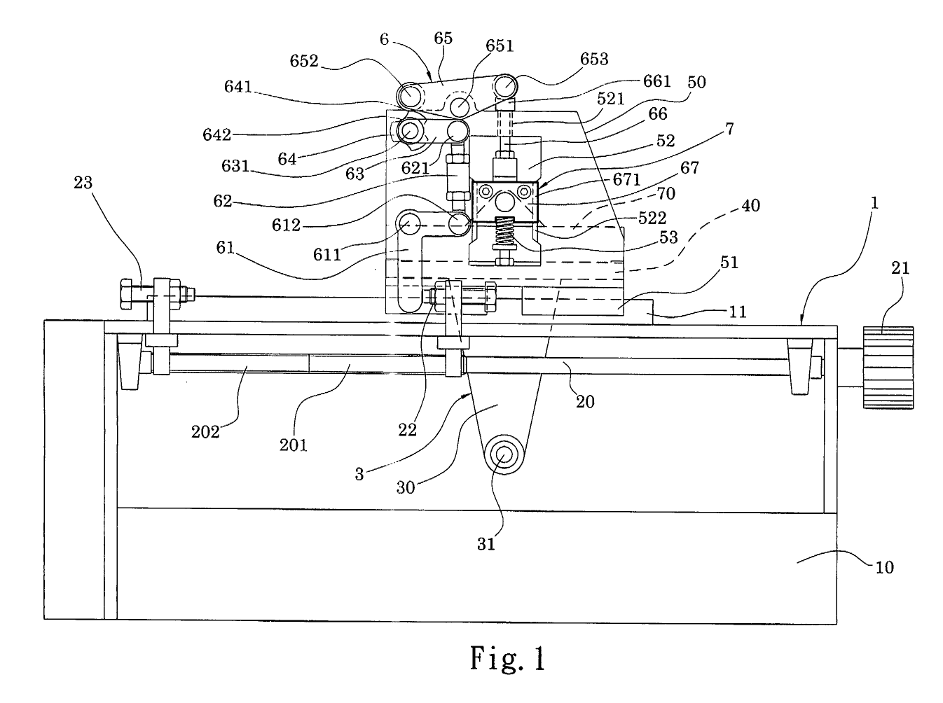

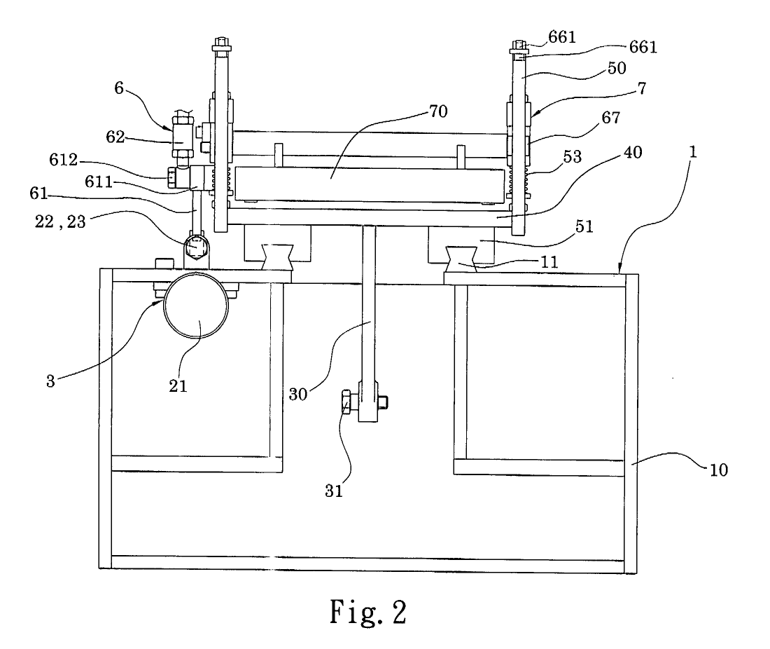

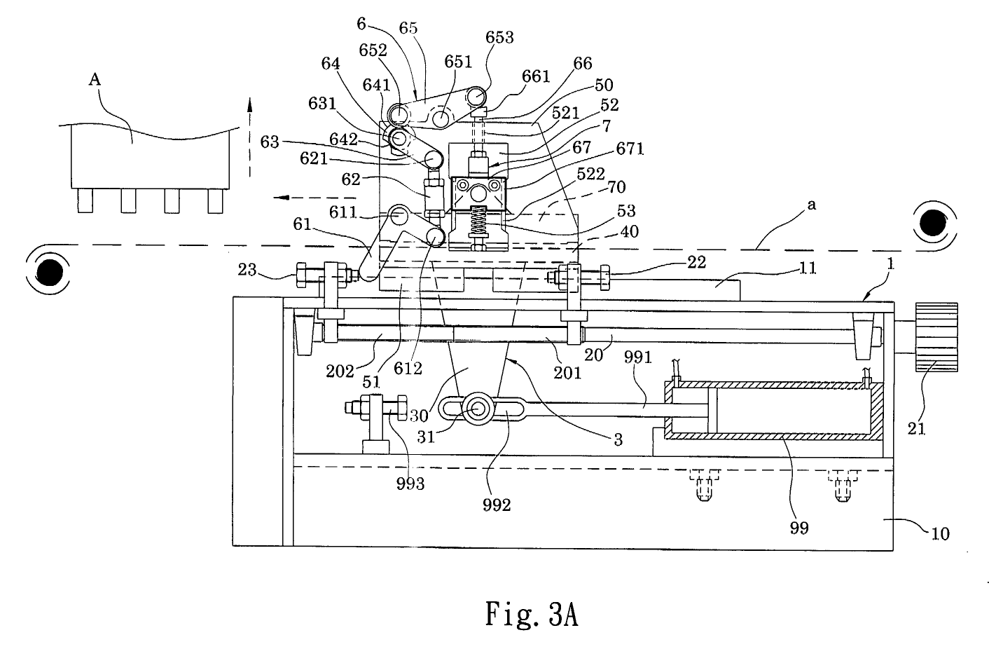

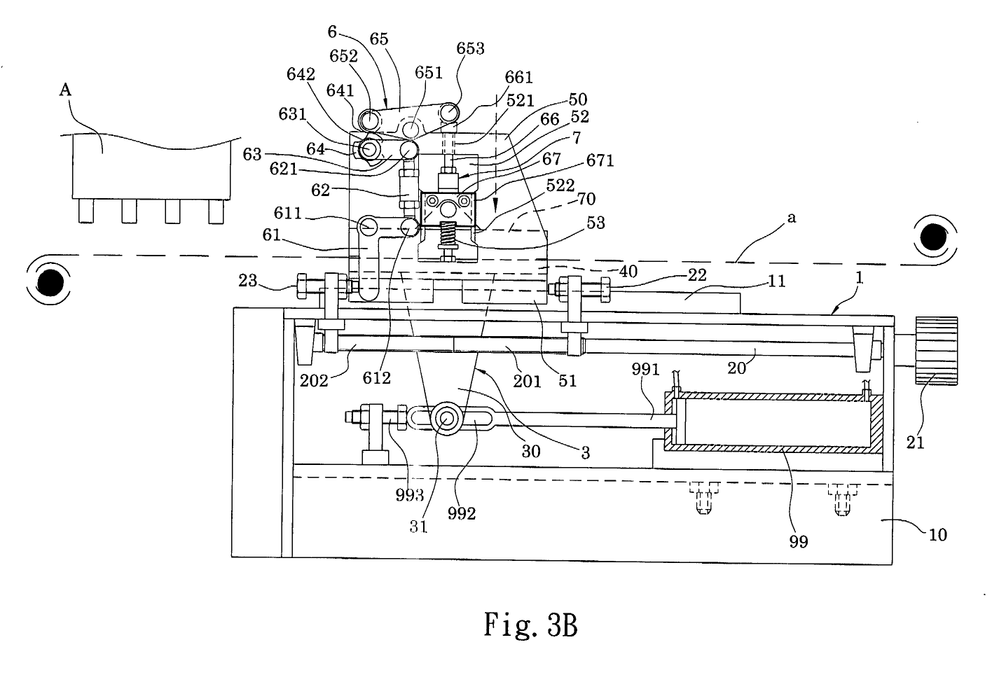

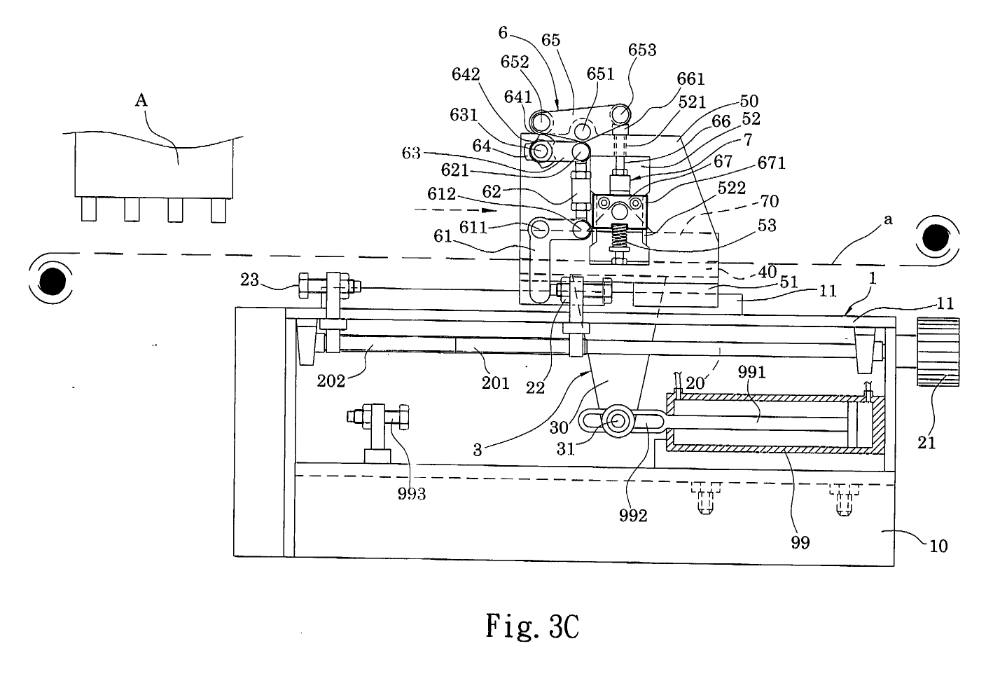

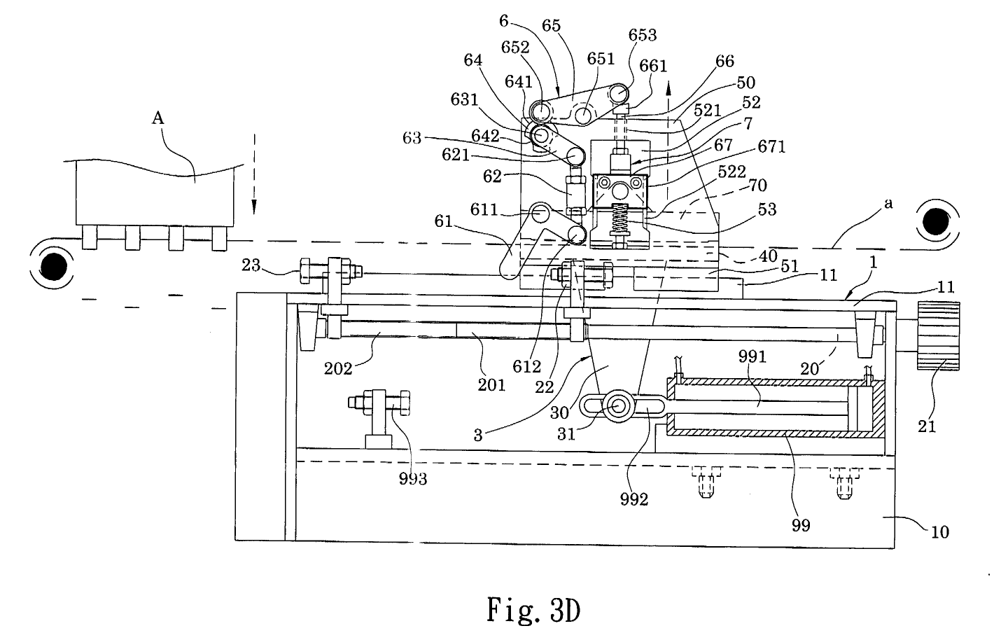

Please refer to FIGS. 1˜2, which are respectively a lateral view and a partial front view showing a pneumatic continuous feeder according to the present invention, and FIGS. 3A˜3D, which are lateral views showing a first kind of operations of the continuous feeder in a first embodiment according to the present invention. As shown, the pneumatic continuous feeder of the present invention includes a base 1, which has a seat 10 having an adjusting shaft 20 thereon with a sliding track 11 at the top of the shaft, wherein the adjusting shaft 20 has a reverse thread region 201 and an obverse thread region 202 which respectively have, mounted thereon, a push-forward rejecting element 22 and a push-backward rejecting element 23 overhead the seat 10, so that through turning an adjusting knob 21 at the front end of the adjusting shaft 20, the push-forward rejecting element 22 and the push-backward rejecting element 23 can reversely move synchronously; a moving unit 3, which has a driving seat 30 having a pivot 31, wherein the driving seat 30 is pivotally mounted in an adjusting hole 992 on a push-pull shaft 991 through the pivot 31, and the other end of the push-pull shaft 991 is extended into the cylinder 99, so that the driving seat 30 can be moved through being driven by the cylinder 99, and a fixing clip 40 with a side plate 50 respectively mounted at two sides thereof is fixedly connected to the top of the driving seat 30, wherein the side plates 50 respectively have an operating space 52 and at least one sliding seat 51, which is installed in the sliding track 11, fixedly mounted thereunder, so that a cylinder 99 can continuously drive the moving unit 3 to slide back and forth on the sliding track 11 of the base 1; a brake unit 6 having a wrench element 61 pivotally connected to the side plate 50 through a central pivot 611, wherein one end of the wrench element 61 can have a swing after collided by the push-forward rejecting element 22 and the push-backward rejecting element 23 and the other end is pivotally connected to a connecting shaft 62, the other end of the connecting shaft 62 is connected to a swing shaft 63 through a pivot 612, the other end of the swing shaft 63 is pivoted on the side plate 50 through a pivot 631 and a cam 64, the cam 64 has at least one convex surface 641 and at least one concave surface 642, a lever 65 is pivotally positioned on the side plate 50 through a central pivot 651, and on one end of the lever 65, a sliding axle 652 is mounted which can drive the cam 64 to slide from the convex surface 641 to the concave surface 642 or from the concave surface 642 to the convex surface 641 when the swing shaft 63 swings, so as to upwardly and downwardly move an operating shaft 653 at the other end of the lever 65; and an operating unit 7 having a transmission shaft 66, which has a force-suffering end 661 mounted at the top thereof for suffering the pressure from the operating shaft 653 so as to move upwardly and downwardly, has a balance block 67 fixedly connected at the bottom thereof, wherein a flexible element 53 for providing recovery is connected at the bottom of the balance block 67 and is fixedly mounted on the side plate 50 through the bottom thereof, and the balance block 67 has a mobile clip 70 located at the top of the fixing clip 40 for downwardly clipping or upwardly releasing the material a; wherein the side plate 50 has an operating space 52 thereon, whose two sides have a track 522 for sliding therein a groove 671, which is oppositely mounted at two sides of the balance block 67, and whose top has a through hole 521 mounted thereon for stably moving the transmission shaft 66 upwardly and downwardly, so that through the cylinder 99 continuously driving the fixing clip 40 to move back and forth equidistantly and driving the mobile clip 70 at the top of the fixing clip 40, the material can be downwardly clipped or upwardly released after the wrench element 61 collides with the push-forward rejecting element 22 or the push-backward rejecting element 23, for continuously feeding, precisely driving the movement of the material a in processing, and continuously and accurately driving the material a to move to the operation tool A for processing.

Further, please refer to FIGS. 3A˜3D, which are lateral views showing a first kind of operations of the continuous feeder in a first embodiment according to the present invention. As shown in FIG. 3A, when the cylinder 99 constantly moves, the driving seat 30 can rejected and pushed. However, since the fixing clip 40 is fixedly connected at the top of the driving seat 30, the side plate 50 is mounted at two sides of the fixing clip 40, at least one sliding seat 51 is respectively mounted at the bottom of the side plates 50, and the sliding seats 51 are slid in the sliding track 11, the moving unit 3, the brake unit 6 and the operating unit 7 above the sliding track 11 are in a moving state and the mobile clip 70 at the top of the fixing clip 40 does not downwardly clip the material a. When the cylinder 99 constantly moves to the position as shown in FIG. 3B, the wrench element 61 is collided by the push-backward rejecting element 23 to swing, so that the connecting shaft 62 moves upwardly to upwardly swing the swing shaft 63 and rotate the cam 64 to the convex surface 641 to reject the sliding axle 652 of the lever 65. Then, the operating shaft 653 of the lever 65 moves downwardly to press the force-suffering end 611 at the top of the transmission shaft 66 for downwardly move the mobile clip 70, which is fixedly mounted on the balance block 67, so as to tightly clip the material a together with the fixing clip 40. When the cylinder 99 constantly moves, as shown in FIG. 3C, the mobile clip 70 and the fixing clip 40 can drive the material a by a pulling method for the soft material to the position as shown in FIG. 3D, and then, the wrench element 61 collides with the push-forward rejecting element 22 to generate swing for downwardly moving the connecting shaft 62. At this time, the swing shaft 63 downwardly swings to rotate the cam 64, so that the balance block 67 at the bottom of the transmission shaft 66 suffers the recovery from the flexible element 53 under the balance block 67 so as to upwardly reject the balance block 67, and then, the force-suffering end 661 of the transmission shaft 66 rejects and pushes the operating shaft 653 to slide the lever 65 into the concave surface 642. Therefore, the mobile clip 70, which is fixedly mounted on the balance block 67, is upwardly moved to release the material a, and then, if the cylinder 99 constantly moves, the material a can be constantly driven in a pull manner, as shown in FIGS. 3A˜3D, so as to be precisely and continuously moved to the operation tool A for processing.

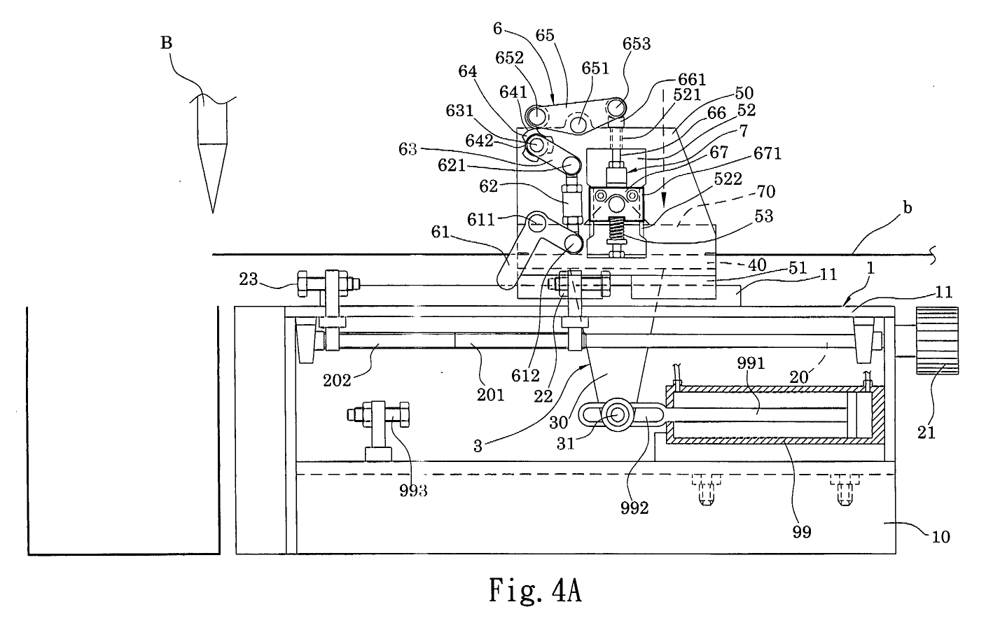

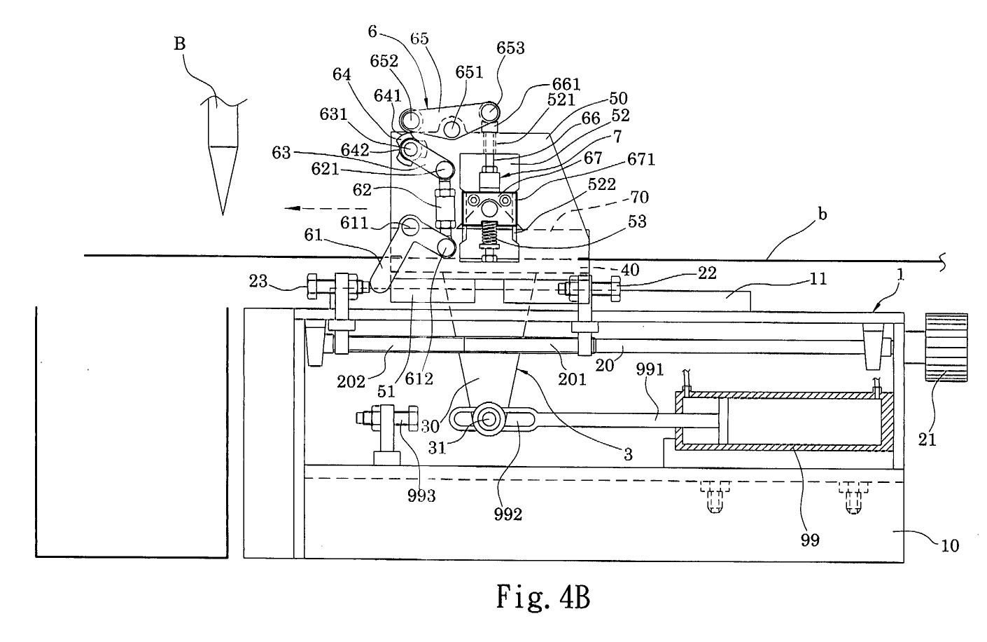

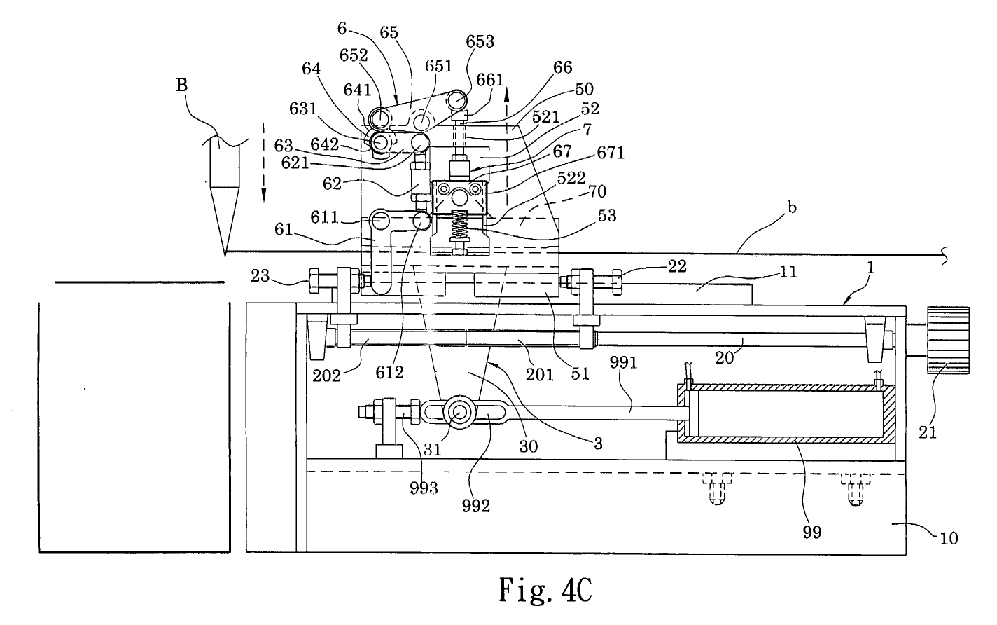

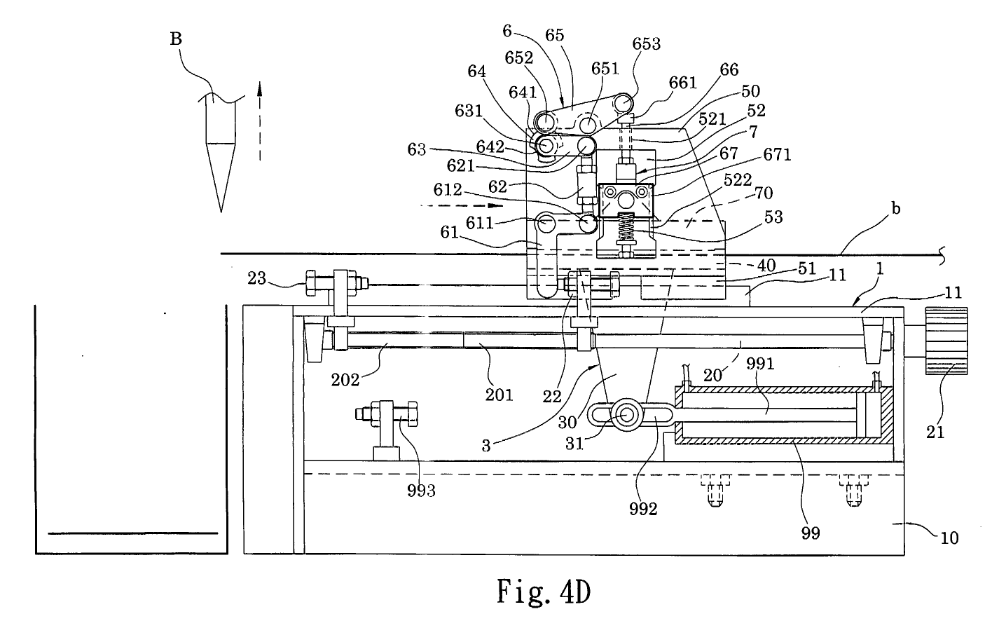

Further, please refer to FIGS. 4A˜4D, which are lateral views showing a second kind of operations of the pneumatic continuous feeder in a first embodiment according to the present invention. As shown in FIG. 4A, the relationship of the cam 64 and the swing shaft 63 is opposite to that in FIG. 3A. When the cylinder 99 constantly moves, the driving seat 30 can be rejected and pushed through being driven by the cylinder 99. However, since the fixing clip 40 is fixedly connected at the top of the driving seat 30, the side plate 50 is mounted at two sides of the fixing clip 40, at least one sliding seat 51 is respectively mounted at the bottom of the side plates 50, and the sliding seats 51 are slid in the sliding track 11, the moving unit 3, the brake unit 6 and the operating unit 7 above the sliding track 11 are in a moving state, so that the wrench element 61 collides with the push-forward rejecting element 22 to generate swing for downwardly moving the connecting shaft 62. At this time, the swing shaft 63 downwardly swings to rotate the cam 64 to the convex surface 641 for rejecting the sliding shaft 652 of the lever 65, so that the operating shaft 653 of the lever 65 is downwardly moved to press the force-suffering end 661 of the transmission shaft 66. Therefore, the mobile clip 70, which is fixedly mounted on the balance block 67, is upwardly moved to release the material b. Since the cylinder 99 moves to the position as shown in FIG. 4B, the mobile clip 70 and the fixing clip 40 can drive the material b by a pushing method for the hard material. When the cylinder 99 constantly moves to the position as shown in FIG. 4C, the wrench element 61 collides with the push-backward rejecting element 23 to generate swing for upwardly moving the connecting shaft 62 so as to upwardly swing the swing shaft 63, so that the balance block 67 at the bottom of the transmission shaft 66 suffers the recovery from the flexible element 53 under the balance block 67 so as to upwardly reject the balance block 67, and then, the force-suffering end 661 of the transmission shaft 66 rejects and pushes the operating shaft 653 to slide the lever 65 into the concave surface 642 of the cam 64. Therefore, the mobile clip 70, which is fixedly mounted on the balance block 67, is upwardly moved to release the material b, which is therefore precisely and continuously moved to the operation tool B for processing. Then, since the cylinder 99 continuously moves, the mobile clip 70 and the fixing clip 40 in the state of releasing the material b is moved to the position as shown in FIG. 4D, and if the cylinder 99 constantly moves, as shown in FIGS. 4A˜4D, the material b can be constantly driven in a push manner so as to be precisely and continuously moved to the operation tool B for processing.

It should be noticed that, as clearly shown in FIGS. 3A˜3D and FIGS. 4A˜4D, the present invention not only can precisely drive the movement of the materials a, b in the processing, but also can continuously and accurately drive the materials a, b to the operation tools A, B for processing, and further, according to the hardness degrees of the materials a, b, the pulling or pushing method can be selected to drive the movement.

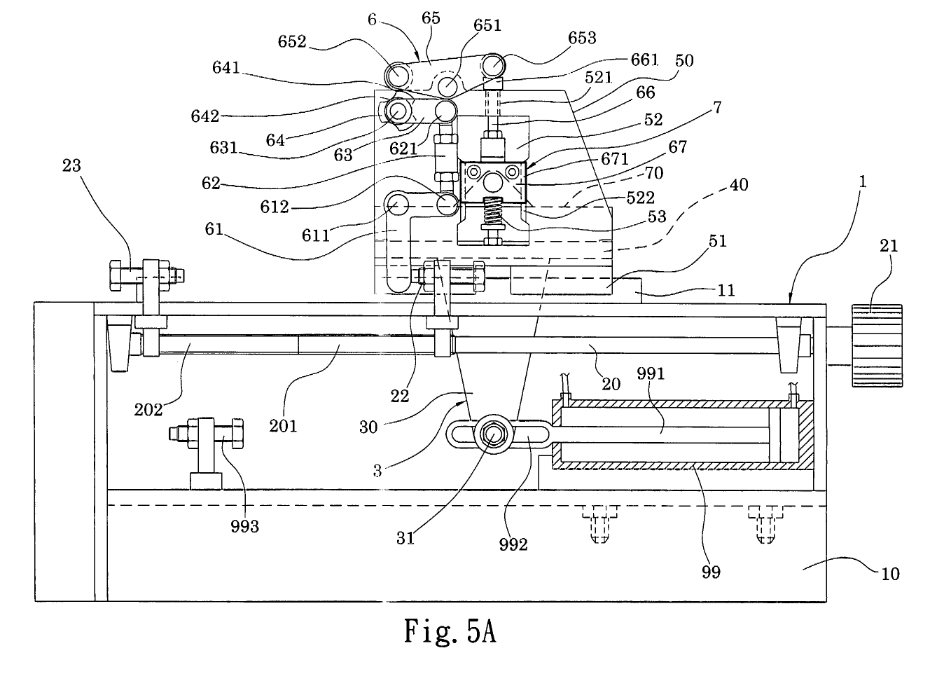

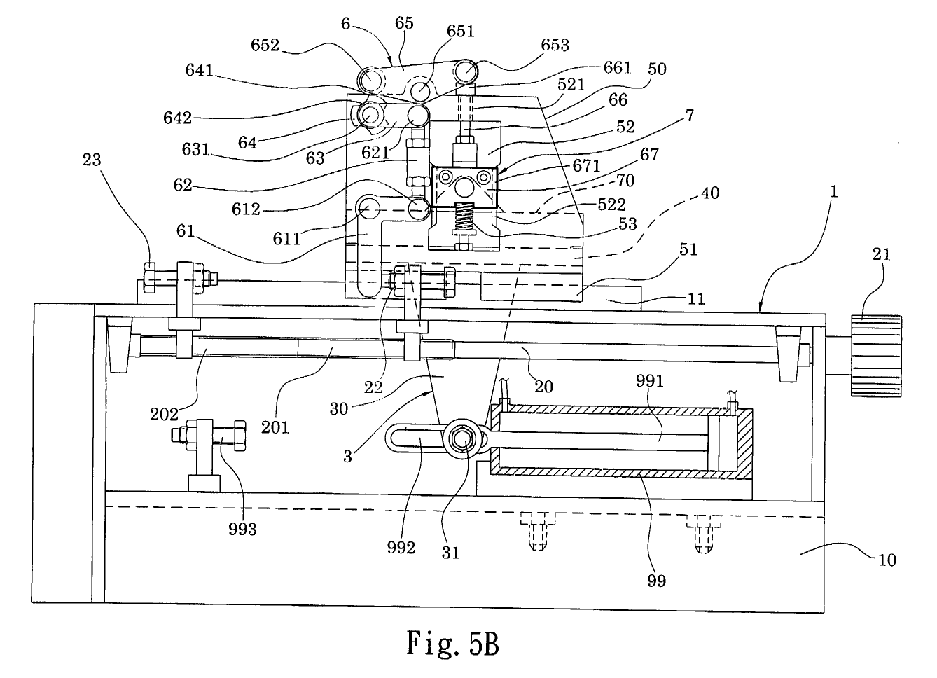

Furthermore, please refer to FIG. 5A and FIG. 5B, which are lateral views showing the adjusting operations for the movement of the pneumatic continuous feeder according to the present invention. As shown, the driving seat 30 has a pivot 31, which is pivotally mounted in an adjusting hole 992 on a push-pull shaft 991, and the other end of the push-pull shaft 991 is extended in to the cylinder 99, so that the driving seat 30 can be moved by the cylinder 99. Besides, since the length of the push-pull shaft 991 exposed out of the cylinder 99 is limited by the pivoting position between the adjusting hole 992 and the pivot 31, or the position of cylinder 99, or even the adjusting screw 993, which is fixedly mounted on the seat 10 for adjusting movement, when there is the need to adjust the movement of material (not shown) in processing, it can change the position of the cylinder 99, or simultaneously change the pivoting position between the adjusting hole 992 and the pivot 31, or even adjust the adjusting screw 993 fixedly mounted on the seat 10 cooperating with turning the adjusting knob 21 at the front end of the adjusting shaft 20, so as to change the collided position on the wrench element 61 by the push-forward rejecting element 22 and the push-backward rejecting element 23 and thus restrict a precise moving distance for the material. Therefore, this embodiment not only can precisely adjust the movement of the material in processing so as to continuously and accurately drive the material (not shown) to the operation tool for processing, but also can change the driving method for the material to be pull or push in response to the hardness degree of the material (not shown). In addition, the cylinder 99 can be driven by the air outputted by an air compressor (not shown).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A pneumatic continuous feeder used to precisely drive a material to an operation tool for processing, comprising:
a base, having a push-forward rejecting element and a push-backward rejecting element;
a moving unit, having a fixing clip, which is driven by a cylinder to move back and forth on the base;
an operation unit, having a mobile clip, which is fixed overhead the fixing clip for downwardly clipping or upwardly releasing the material; and
a brake unit, having a wrench element, which is collided by the push-forward rejecting element and the push-backward rejecting element so as to generate a connecting rod operation for pressing the operation unit to move upwardly and downwardly,
wherein through the cylinder continuously driving the fixing clip to move back and forth equidistantly and driving the mobile clip at the top of the fixing clip, the material is downwardly clipped or upwardly released after the wrench element collides with the push-forward rejecting element or the push-backward rejecting element, so as to achieve a continuous feeding.

2. The pneumatic continuous feeder as claimed in claim 1, wherein the base has a seat having an adjusting shaft thereon, and the adjusting shaft has a reverse thread region and an obverse thread region which respectively have, mounted thereon, the push-forward rejecting element and the push-backward rejecting element overhead the seat, so that through turning an adjusting knob at the front end of the adjusting shaft, the push-forward rejecting element and the push-backward rejecting element are capable of moving reversely and synchronously, and the seat further has a sliding track mounted thereon.

3. The pneumatic continuous feeder as claimed in claim 2, wherein the moving unit has a driving seat, the driving seat is pivotally mounted in an adjusting hole on a push-pull shaft through a pivot and the other end of the push-pull shaft is extended into the cylinder, and further, the fixing clip with a side plate respectively mounted at two sides thereof is fixedly connected to the top of the driving seat, the side plates respectively have an operating space and at least one sliding seat fixedly mounted thereunder, and the sliding seat is installed in the sliding track for sliding thereon.

4. The pneumatic continuous feeder as claimed in claim 3, wherein the wrench element of the brake unit is pivotally connected to the side plate through a central pivot, one end of the wrench element has a swing after collided by the push-forward rejecting element and the push-backward rejecting element and the other end is pivotally connected to a connecting shaft, the other end of the connecting shaft is connected to a swing shaft through a pivot, the other end of the swing shaft is pivoted on the side plate through a pivot and a cam, the cam has at least one convex surface and at least one concave surface, a lever is pivotally positioned on the side plate through a central pivot, and a sliding axle is mounted on one end of the lever for sliding from the convex surface to the concave surface or from the concave surface to the convex surface when the swing shaft swings to drive the cam, so as to upwardly and downwardly move an operating shaft at the other end of the lever.

5. The pneumatic continuous feeder as claimed in claim 4, wherein the operation unit has a transmission shaft, the transmission shaft has a force-suffering end mounted at the top thereof for suffering the pressure from the operating shaft so as to move upwardly and downwardly, a balance block is fixedly connected at the bottom of the transmission shaft, a flexible element for providing recovery is connected at the bottom of the balance block, the side plate is fixedly mounted at the bottom of the flexible element, and the balance block is fixedly mounted at the top of the mobile clip.

6. The pneumatic continuous feeder as claimed in claim 5, wherein the side plate has an operating space thereon, whose two sides have a track for sliding therein a groove, which is oppositely mounted at two sides of the balance block, and whose top has a through hole mounted thereon for stably moving the transmission shaft upwardly and downwardly.

7. The pneumatic continuous feeder as claimed in claim 6, wherein a length of the push-pull shaft exposed out of the cylinder is limited by the pivoting position between the adjusting hole and the pivot, or the position of the cylinder, or even the adjusting screw, which is fixedly mounted on the seat for adjusting movement.

8. The pneumatic continuous feeder as claimed in claim 1, wherein the cylinder is driven by the air outputted by an air compressor.
